(19) United States
(12) Patent Application Publication
(10) Pub. No.: US 2015/0188467 A1
(43) Pub. Date: Jul. 2, 2015

(54) ZERO CROSSING POINT ESTIMATING CIRCUIT, MOTOR DRIVING CONTROL APPARATUS AND METHOD USING THE SAME

(71) Applicant: SAMSUNG ELECTRO-MECHANICS CO., LTD., Suwon-si (KR)

(72) Inventor: Bon Young GU, Suwon-si (KR)

(73) Assignee: SAMSUNG ELECTRO-MECHANICS CO., LTD., Suwon-si (KR)

(21) Appl. No.: 14/226,663

(22) Filed: Mar. 26, 2014

(30) Foreign Application Priority Data
Dec. 30, 2013 (KR) 10-2013-0166591

(51) Int. Cl. H02P 6/18; H02P 23/14; H02P 6/00

(52) U.S. Cl. CPC H02P 6/182; H02P 6/001; H02P 23/14

(57) ABSTRACT

A motor driving control apparatus may include: back-electromotive force detecting unit detecting back-electromotive force generated by a motor apparatus; a zero crossing point estimating unit estimating a zero crossing point by performing at least one of differentiation and integration on a voltage difference between the back-electromotive force and a preset reference voltage; and a controlling unit controlling phase switching of the motor apparatus using the zero crossing point.

### CROSS-REFERENCE TO RELATED APPLICATION

This application claims the benefit of Korean Patent Application No. 10-2013-0166591, filed on Dec. 30, 2013, with the Korean Intellectual Property Office, the disclosure of which is incorporated herein by reference.

### BACKGROUND

The present disclosure relates to a zero crossing point estimating circuit, and a motor driving control apparatus and method using the same.

In accordance with the development of motor technology, motors having various sizes have been used in various technical fields.

Generally, such motors are driven by rotating a rotor using a permanent magnet and a coil having polarities changed depending on a current applied thereto. One such motor is a brush type motor having a coil disposed on a rotor. However, the brush type motor may be problematic in that a brush may be worn out or a sparking may occur due to the driving of the motor.

For this reason, various types of brushless motors have been commonly used recently. A brushless motor is a Direct Current (DC) motor driven using an electronic commutation mechanism instead of mechanical contact parts such as a brush, a commutator, and the like. Such a brushless motor may generally a stator including coils corresponding to a plurality of phases and generating magnetic forces by phase voltages of the respective coils and a rotor formed of a permanent magnet and rotating by the magnetic forces of the stator.

In order to control the driving of the brushless motor, it is necessary to confirm a position of the rotor so as to alternately provide phase voltages. According to the related art, the position of the rotor has been estimated using back-electromotive force in order to confirm the position of the rotor. A point in time of phase switching has been determined based on the estimated position of the rotor.

However, in the related art as described above, in the case in which an error occurs in a specific zero crossing point, it is difficult to solve such an error. Particularly, in the case in which an offset occurs in a reference voltage of the zero crossing point or an error is present in detected back-electromotive force, the zero crossing point may not be detected. In this case, there may be problems in that the phase switching is not appropriately performed and the motor pulsates.

### SUMMARY

An exemplary embodiment in the present disclosure may provide a zero crossing point estimating circuit capable of preventing an error in detecting a zero crossing point and smoothly performing driving of a motor apparatus by detecting error forms of back-electromotive force and a reference voltage using a differentiation value and an integration value of the back-electromotive force and the reference voltage and estimating the zero crossing point depending on the error form, and a motor driving control apparatus and method using the same.

According to an exemplary embodiment in the present disclosure, a motor driving control apparatus may include: back-electromotive force detecting unit detecting back-electromotive force generated by a motor apparatus; a zero crossing point estimating unit estimating a zero crossing point by performing at least one of differentiation and integration on a voltage difference between the back-electromotive force and a preset reference voltage; and a controlling unit controlling phase switching of the motor apparatus using the zero crossing point.

The zero crossing point estimating unit may estimate the zero crossing point by performing at least one of the differentiation and the integration on the voltage difference when the zero crossing point is not detected by the back-electromotive force and the reference voltage.

The zero crossing point estimating unit may judge that the zero crossing point is detected by the back-electromotive force and the reference voltage when an integration value of the voltage difference is 0.

The zero crossing point estimating unit may judge whether the back-electromotive force and the reference voltage correspond to any one of preset forms depending on a result of the differentiation or the integration and estimate the zero crossing point depending on the judged form.

The zero crossing point estimating unit may estimate a central point of a floating section to be the zero crossing point when a differentiation value of the voltage difference has a positive value within an entire region of the floating section and an integration value thereof is not 0.

The zero crossing point estimating unit may estimate a central point of a floating section to be the zero crossing point when a differentiation value of the voltage difference has a negative value within an entire region of the floating section and an integration value thereof is not 0.

The zero crossing point estimating unit may estimate a central point of a first section to be the zero crossing point when a polarity of a differentiation value of the voltage difference is changed during a floating section and the first section corresponding to a first polarity of the differentiation value is longer than a second section corresponding to a second polarity thereof.

According to an exemplary embodiment in the present disclosure, a zero crossing point estimating circuit may include: a subtractor outputting a voltage difference between back-electromotive force and a present reference voltage; a differentiator differentiating the voltage difference with respect to a floating section; an integrator integrating the voltage difference with respect to the floating section; and a zero crossing point estimator estimating a zero crossing point using at least one of an output of the differentiator and an output of the integrator.

The zero crossing point estimator may estimate a central point of the floating section to be the zero crossing point when the output of the integrator is 0.

The zero crossing point estimating circuit may further include a pattern determiner determining whether the back-electromotive force and the reference voltage correspond to any one of preset forms depending on a result of the differentiation or the integration, wherein the zero crossing point estimator estimates the zero crossing point depending on an output of the pattern determiner.

The zero crossing point estimator may estimate a central point of the floating section to be the zero crossing point when the output of the differentiator has a positive value within an entire region of the floating section and the output of the integrator is not 0.

The zero crossing point estimator may estimate a central point of the floating section to be the zero crossing point when the output of the differentiator has a negative value within an entire region of the floating section and the output of the integrator is not 0.

The zero crossing point estimator may estimate a central point of a first section to be the zero crossing point when a polarity of the output of the differentiator is changed within the floating section and the first section corresponding to a first polarity of the output of the differentiator is longer than a second section corresponding to a second polarity thereof.

According to an exemplary embodiment in the present disclosure, a motor driving control method performed by a motor driving control apparatus of controlling driving of a motor apparatus may include: detecting back-electromotive force generated by the motor apparatus; estimating a zero crossing point by performing at least one of differentiation and integration on a voltage difference between the back-electromotive force and a preset reference voltage; and controlling phase switching of the motor apparatus using the zero crossing point.

In the estimating of the zero crossing point, it may be judged that the zero crossing point is detected by the back-electromotive force and the reference voltage when an integration value of the voltage difference is 0.

In the estimating of the zero crossing point, it may be judged whether the back-electromotive force and the reference voltage correspond to any one of preset forms depending on a result of the differentiation or the integration, and the zero crossing point may be estimated depending on the judged form.

In the estimating of the zero crossing point, a central point of a floating section may be estimated to be the zero crossing point when a differentiation value of the voltage difference has a positive value within an entire region of the floating section and an integration value thereof is not 0.

In the estimating of the zero crossing point, a central point of a floating section may be estimated to be the zero crossing point when a differentiation value of the voltage difference has a negative value within an entire region of the floating section and an integration value thereof is not 0.

In the estimating of the zero crossing point, a central point of a first section may be estimated to be the zero crossing point when a polarity of a differentiation value of the voltage difference is changed during a floating section and the first section corresponding to a first polarity of the differentiation value is longer than a second section corresponding to a second polarity thereof.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a configuration diagram illustrating an example of a motor driving control apparatus according to an exemplary embodiment of the present disclosure;

FIG. 2 is a graph showing an example of back-electromotive forces detected at a plurality of phases of the motor;

FIG. 3 is a configuration diagram illustrating an example of a zero crossing point estimating circuit according to an exemplary embodiment of the present disclosure;

FIGS. 4 through 6 are graphs showing cases that may occur between back-electromotive force and a reference voltage; and

FIG. 7 is a flow chart illustrating an example of a motor driving control method according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

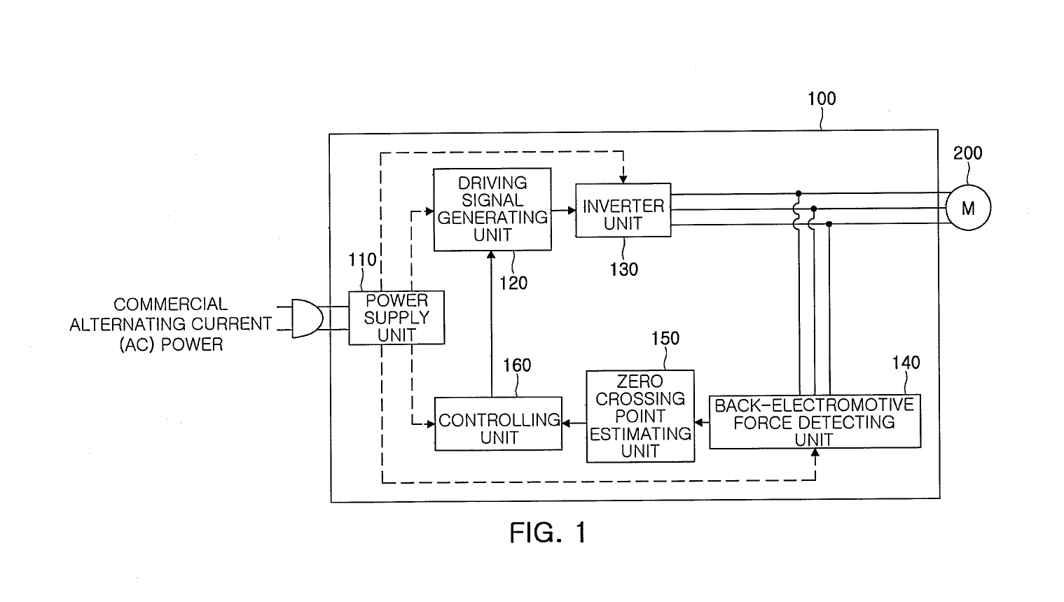

FIG. 1 is a configuration diagram illustrating an example of a motor driving control apparatus according to an exemplary embodiment of the present disclosure.

A motor driving control apparatus 100 may provide a predetermined signal, for example, a driving signal to a motor apparatus 200 to control a rotation operation of the motor apparatus 200.

The motor apparatus 200 may perform the rotation operation according to the driving signal. For example, the respective coils of the motor apparatus 200 may generate magnetic fields by a driving current (driving signal) provided from an inverter unit 130. A rotor included in the motor apparatus 200 may rotate by the magnetic fields generated by the coils as described above.

Referring to FIG. 1, the motor driving control apparatus 100 may include a power supply unit 110, a driving signal generating unit 120, the inverter unit 130, back-electromotive force detecting unit 140, a zero crossing point estimating unit 150, and a controlling unit 160.

The power supply unit 110 may supply power to the respective components of the motor driving control apparatus 100. For example, the power supply unit 110 may convert an alternating current (AC) voltage of commercial power into a direct current (DC) voltage and supply the DC voltage to the respective components. In an example shown in FIG. 1, a dotted line indicates predetermined power supplied from the power supply unit 110.

The driving signal generating unit 120 may control the inverter unit 130 to generate the driving signal.

The inverter unit 130 may provide the driving signal to the motor apparatus 200. Therefore, the inverter unit 130 may convert the DC voltage into a plurality of phase voltages (for example, three phase voltages) depending on the predetermined signal provided from the driving signal generating unit 120. The inverter unit 130 may apply the plurality of phase voltages to a plurality of coils of the motor apparatus 200 corresponding to a plurality of phases, respectively, to allow the rotor of the motor apparatus 200 to be operated.

The back-electromotive force detecting unit 140 may detect back-electromotive force generated by the motor apparatus 200. The back-electromotive force detecting unit 140 may detect back-electromotive force applied at a specific phase in a floating section.

The zero crossing point estimating unit 150 may estimate a zero crossing point by performing at least one of differentiation and integration on a voltage difference between the back-electromotive force and a preset reference voltage.

In an exemplary embodiment of the present disclosure, the zero crossing point estimating unit 150 may estimate the zero crossing point by performing at least one of the differentiation and the integration on the voltage difference, when the zero crossing point is not detected by the back-electromotive force and the reference voltage. That is, the zero crossing point estimating unit 150 may provide the zero crossing point to the controlling unit 160 in the case in which the zero crossing point is detected and may estimate the zero crossing point in the case in which the zero crossing point is not detected and then provide the estimated zero crossing point to the controlling unit 160.

In an exemplary embodiment of the present disclosure, the zero crossing point estimating unit 150 may judge that the zero crossing point is detected by the back-electromotive force and the reference voltage when an integration value of the voltage difference is 0.

In an exemplary embodiment of the present disclosure, the zero crossing point estimating unit 150 may judge whether the back-electromotive force and the reference voltage correspond to any one of preset forms depending on a result of the differentiation or the integration and may estimate the zero crossing point depending on the judged form.

In an exemplary embodiment of the present disclosure, the zero crossing point estimating unit 150 may estimate a central point of a floating section to be the zero crossing point when the differentiation value of the voltage difference has a positive value within an entire region of the floating section and the integration value thereof is not 0.

In an exemplary embodiment of the present disclosure, the zero crossing point estimating unit 150 may estimate the central point of the floating section to be the zero crossing point when the differentiation value of the voltage difference has a negative value over the entire region of the floating section and the integration value thereof is not 0.

In an exemplary embodiment of the present disclosure, the zero crossing point estimating unit 150 may estimate a central point of a first section to be the zero crossing point when a polarity of the differentiation value of the voltage difference is changed within the floating section and the first section corresponding to a first polarity of the differentiation value is longer than a second section corresponding to a second polarity thereof.

The controlling unit 160 may control phase switching of the motor apparatus 200 using the zero crossing point provided from the zero-crossing point estimating unit 150. The controlling unit 160 may perform a control so that the phase switching is generated after a predetermined angle from the zero crossing point.

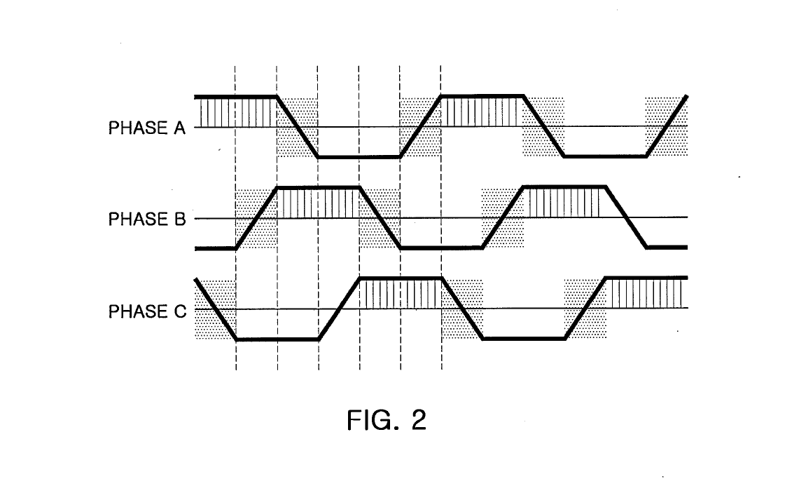

FIG. 2 is a graph showing an example of back-electromotive forces detected at a plurality of phases of the motor. FIG. 2 shows an example of a three-phase motor.

As shown in FIG. 2, in the case of the three-phase motor, a driving signal may be applied to a positive pole and a negative pole. A section in which the driving signal is not applied may be a floating section. In this floating section, back-electromotive force may be generated by driving signals applied to other phases. For example, in a first section, the driving signal is applied to a positive pole of a phase A and a negative pole of a phase B. As a result, back-electromotive force is detected in a floating section of a phase C.

FIG. 2 shows an ideal state of the motor. Therefore, a zero crossing point at which the back-electromotive force crosses the reference voltage is necessarily detected in the floating section.

However, due to causes such as an error in detecting the back-electromotive force, a shift of the reference voltage, or the like, in actually driving the motor, the case in which the back-electromotive force is not detected may occur.

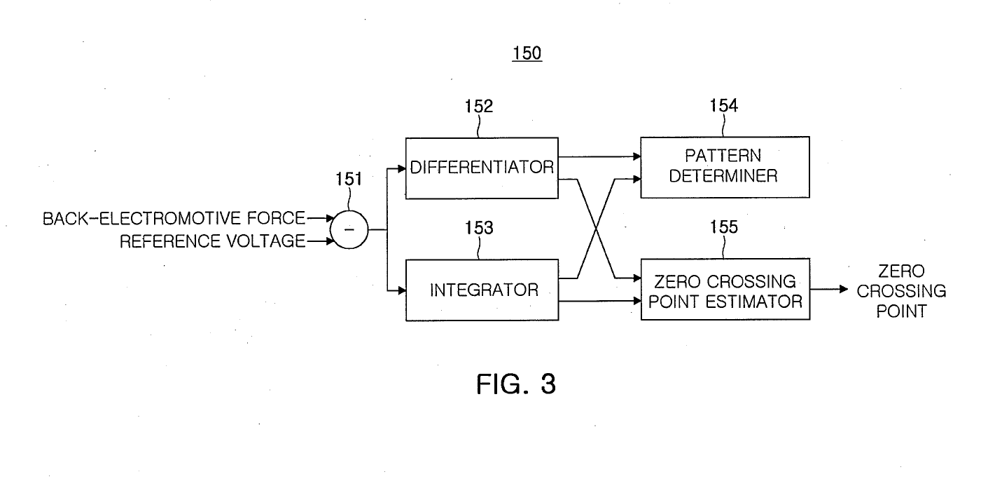

Hereinafter, a method of estimating back-electromotive force in the case in which the back-electromotive force is not appropriately detected will be described with reference to FIGS. 3 through 6.

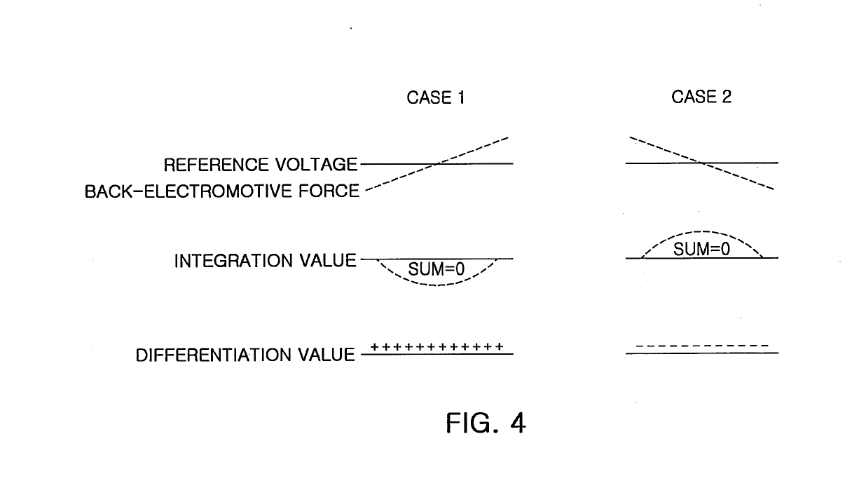

FIG. 3 is a configuration diagram illustrating an example of a zero crossing point estimating circuit according to an exemplary embodiment of the present disclosure. The crossing point estimating circuit shown in FIG. 3 may correspond to the zero crossing point estimating unit shown in FIG. 1. FIGS. 4 through 6 are graphs showing cases that may occur between back-electromotive force and a reference voltage.

First, as shown in FIG. 3, the zero crossing point estimating circuit may include a subtractor 151, a differentiator 152, an integrator 153, and a zero crossing point estimator 155. In some cases, the zero crossing point estimating circuit may further include a pattern determiner 154.

The subtractor 151 may receive back-electromotive force and a preset reference voltage and output a voltage difference between the back-electromotive force and the reference voltage.

The differentiator 152 may differentiate the voltage difference with respect to a floating section, and the integrator 153 may integrate the voltage difference with respect to the floating section.

The zero crossing point estimator 155 may estimate a zero crossing point using at least one of an output of the differentiator 152 and an output of the integrator 153.

In an exemplary embodiment of the present disclosure, the pattern determiner 154 may judge whether the back-electromotive force and the reference voltage correspond to any one of preset forms depending on a result of the differentiation or the integration. The zero crossing point estimator 155 may estimate the zero crossing point depending on an output of the pattern determiner 154.

FIG. 4 shows a form in which the zero crossing point is normally detected by the reference voltage and the back-electromotive force.

It may be appreciated that in CASE 1 and CASE 2 shown in FIG. 4, the zero crossing point is normally detected, and thus, the sum of integration of the difference value between the reference voltage and the back-electromotive force is 0.

In addition, it may be appreciated that in CASE 1, a differentiation value is maintained as a positive value, and in CASE 2, a differentiation value is maintained as a negative value. The reason is that a variation in the differentiation value is not generated since the back-electromotive force has a linear shape.

In the form shown in FIG. 4, the integration value of the voltage difference is 0, and thus, the zero crossing point estimator 155 may judge that the zero crossing point is normally detected by the back-electromotive force and the reference voltage.

In the case in which the zero crossing point estimating circuit may further include the pattern determiner 154, the pattern determiner 154 may judge that the reference voltage and the back-electromotive force correspond to CASE 1 or CASE 2 using integration value and the differentiation value and may provide this information to the zero crossing point estimator 155. The zero crossing point estimator 155 may have a zero crossing point estimating method for each case. Therefore, the zero crossing point estimator 155 may output the normally detected zero crossing point with respect to CASE 1 and CASE 2.

In an exemplary embodiment of the present disclosure, when the output of the integrator is 0, the zero crossing point estimator 155 does not detect the zero crossing point, but may estimate the central point of the floating section to be the zero crossing point. The reason is that the central point of the floating section becomes the zero crossing point in the case in which the zero crossing point is detected in the floating section.

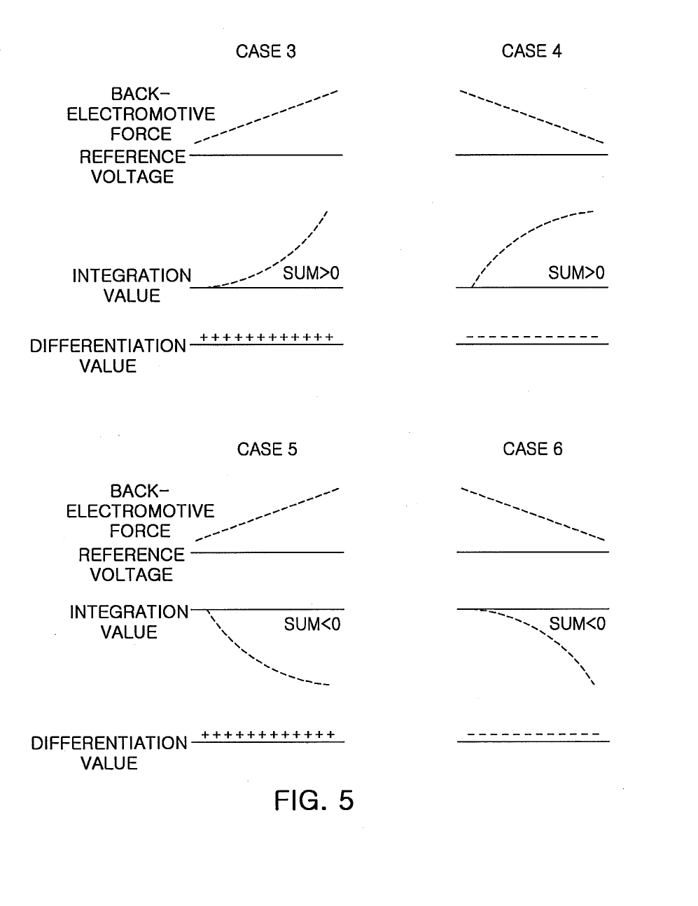

FIG. 5 shows a form in which the reference voltage and the back-electromotive force do not cross with each other in the floating section.

In CASE 3 to CASE 6, the reference voltage and the back-electromotive force do not cross with each other, such that an integration value of a difference value between the reference voltage and the back-electromotive force is larger or smaller than 0. In addition, the back-electromotive force has a linear shape, such that a differentiation value of the difference value has only a specific sign.

Therefore, in these cases, the zero crossing point estimator 155 may estimate the central point of the floating section to be the zero crossing point.

In an exemplary embodiment of the present disclosure, the zero crossing point estimator 155 may estimate the central point of the floating section to be the zero crossing point when the output of the differentiator 152 has a positive value within an entire region of the floating section and the output of the integrator 153 is not 0. That is, in CASE 3 and CASE 5, the zero crossing point estimator 155 may estimate the central point of the floating section to be the zero crossing point.

In an exemplary embodiment of the present disclosure, the zero crossing point estimator 155 may estimate the central point of the floating section to be the zero crossing point when the output of the differentiator 152 has a negative value over the entire region of the floating section and the output of the integrator 153 is not 0. That is, also in CASE 4 and CASE 6, the zero crossing point estimator 155 may estimate the central point of the floating section to be the zero crossing point.

In the case in which the zero crossing point estimating circuit may further include the pattern determiner 154, the pattern determiner 154 may confirm a sign of the sum of integration values for the floating section and a signal of a differentiation value to judge whether the reference voltage and the back-electromotive force correspond to any one of CASE 3 to CASE 6. The zero-crossing point estimator 155 may estimate the central point of the floating section to be the zero crossing point in the case in which CASE 3 to CASE 6 are input from the pattern determiner 154.

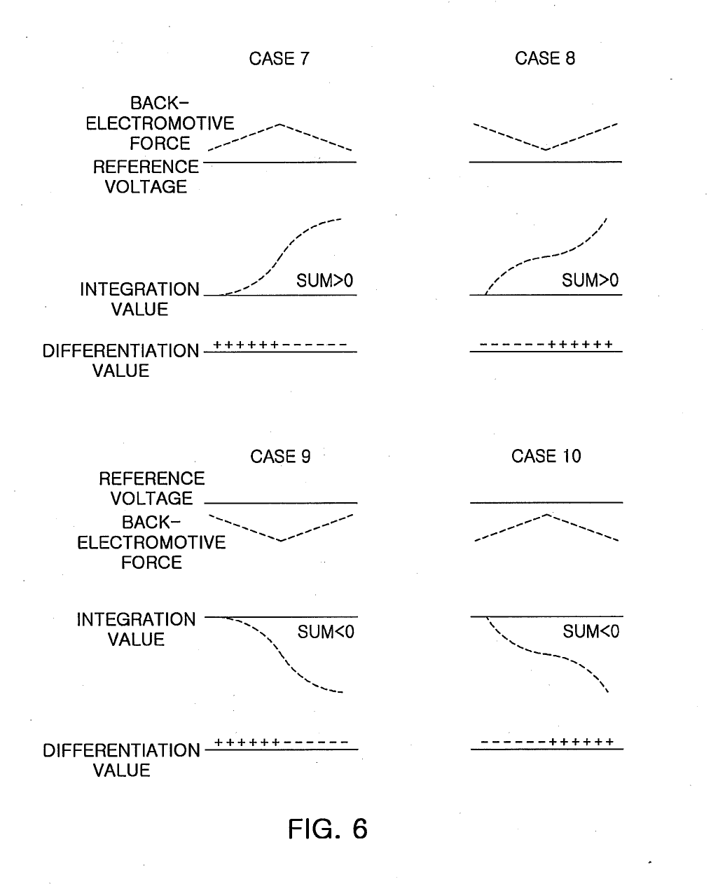

FIG. 6 shows a form in which the reference voltage and the back-electromotive force do not cross with each other in the floating section and the back-electromotive force is inflected.

In CASE 7 and CASE 8, the back-electromotive force is inflected above the reference voltage and does not cross with the reference voltage, such that an integration value of a difference value between the reference voltage and the back-electromotive force is larger than 0 and a sign of a differentiation value thereof is changed based on a point at which the back-electromotive force is inflected.

In CASE 9 and CASE 10, the back-electromotive force is inflected below the reference voltage and does not cross with the reference voltage, such that an integration value of a difference value between the reference voltage and the back-electromotive force is smaller than 0 and a sign of a differentiation value thereof is changed based on a point at which the back-electromotive force is inflected.

Therefore, in these cases, the zero crossing point estimator 155 may estimate a central point of a long side to be the zero crossing point in the case in which a polarity of the output of the differentiator 152 is changed within the floating section. That is, the zero crossing point estimator 155 may estimate a central point of a first section to be the zero crossing point when the first section corresponding to a first polarity of the output of the differentiator is longer than a second section corresponding to a second polarity thereof.

In the case in which the zero crossing point estimating circuit may further include the pattern determiner 154, the pattern determiner 154 may confirm a sign of the sum of integration values for the floating section and a sign of a differentiation value for the floating section to judge whether the reference voltage and the back-electromotive force correspond to any one of CASE 7 to CASE 10. The zero-crossing point estimator 155 may estimate the zero crossing point, as described above, in consideration of the output of the differentiator in the case in which CASE 7 to CASE 10 are input from the pattern determiner 154.

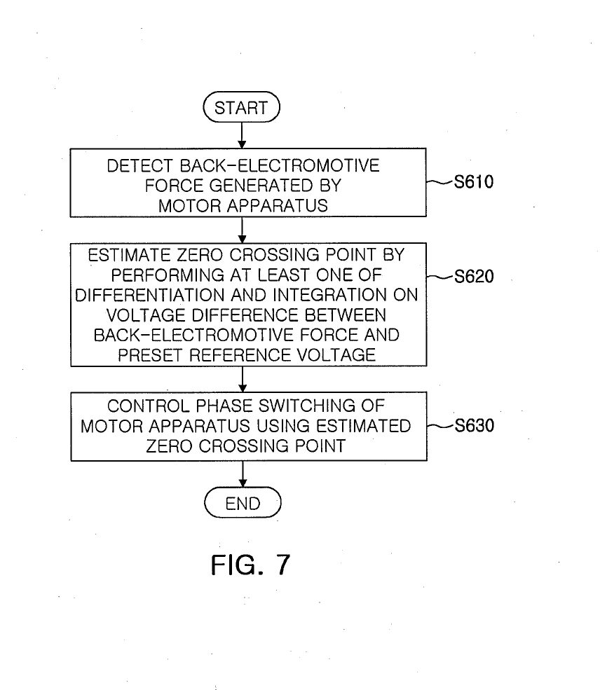

FIG. 7 is a flow chart illustrating an example of a motor driving control method according to an exemplary embodiment of the present disclosure.

Hereinafter, an example of a motor driving control method according to an exemplary embodiment of the present disclosure will be described with reference to FIG. 7. Since an example of a motor driving control method according to an exemplary embodiment of the present disclosure to be described below is performed by the motor driving control apparatus described above with reference to FIGS. 1 through 6, an overlapped description for contents that are the same as or correspond to the above-mentioned contents will be omitted.

Referring to FIG. 7, the motor driving control apparatus 100 may detect the back-electromotive force generated by the motor apparatus 200 (S710).

The motor driving control apparatus 100 may estimate the zero crossing point by performing at least one of the differentiation and the integration on the voltage difference between the back-electromotive force and the preset reference voltage (S720).

The motor driving control apparatus 100 may control the phase switching of the motor apparatus 200 using the estimated zero crossing point (S730).

In an example of S720, the motor driving control apparatus 100 may judge that the zero crossing point is detected by the back-electromotive force and the reference voltage when the integration value of the voltage difference is 0.

In an example of S720, the motor driving control apparatus 100 may judge whether the back-electromotive force and the reference voltage correspond to any one of preset forms depending on a result of the differentiation or the integration and may estimate the zero crossing point depending on the judged form.

In an example of S720, the motor driving control apparatus 100 may estimate the central point of the floating section to be the zero crossing point when the differentiation value of the voltage difference has a positive value over the entire region of the floating section and the integration value thereof is not 0.

In an example of S720, the motor driving control apparatus 100 may estimate the central point of the floating section to be the zero crossing point when the differentiation value of the voltage difference has a negative value over the entire region of the floating section and the integration value thereof is not 0.

In an example of S720, the motor driving control apparatus 100 may estimate the central point of the first section to be the zero crossing point when the polarity of the differentiation value of the voltage difference is changed within the floating section and the first section corresponding to the first polarity of the differentiation value is longer than the second section corresponding to the second polarity thereof.

As set forth above, according to exemplary embodiments of the present disclosure, error forms of back-electromotive force and a reference voltage are detected using a differentiation value and an integration value of the back-electromotive force and the reference voltage and the zero crossing point is estimated depending on the error form, whereby an error in detecting a zero crossing point may be prevented and driving of a motor apparatus may be smoothly performed.

While exemplary embodiments have been shown and described above, it will be apparent to those skilled in the art that modifications and variations could be made without departing from the spirit and scope of the present disclosure as defined by the appended claims.

What is claimed is:

1. A motor driving control apparatus, comprising:
back-electromotive force detecting unit detecting back-electromotive force generated by a motor apparatus;
a zero crossing point estimating unit estimating a zero crossing point by performing at least one of differentiation and integration on a voltage difference between the back-electromotive force and a preset reference voltage; and
a controlling unit controlling phase switching of the motor apparatus using the zero crossing point.

2. The motor driving control apparatus of claim 1, wherein the zero crossing point estimating unit estimates the zero crossing point by performing at least one of the differentiation and the integration on the voltage difference when the zero crossing point is not detected by the back-electromotive force and the reference voltage.

3. The motor driving control apparatus of claim 2, wherein the zero crossing point estimating unit judges that the zero crossing point is detected by the back-electromotive force and the reference voltage when an integration value of the voltage difference is 0.

4. The motor driving control apparatus of claim 1, wherein the zero crossing point estimating unit judges whether the back-electromotive force and the reference voltage correspond to any one of preset forms depending on a result of the differentiation or the integration and estimates the zero crossing point depending on the judged form.

5. The motor driving control apparatus of claim 1, wherein the zero crossing point estimating unit estimates a central point of a floating section to be the zero crossing point when a differentiation value of the voltage difference has a positive value within an entire region of the floating section and an integration value thereof is not 0.

6. The motor driving control apparatus of claim 1, wherein the zero crossing point estimating unit estimates a central point of a floating section to be the zero crossing point when a differentiation value of the voltage difference has a negative value within an entire region of the floating section and an integration value thereof is not 0.

7. The motor driving control apparatus of claim 1, wherein the zero crossing point estimating unit estimates a central point of a first section to be the zero crossing point when a polarity of a differentiation value of the voltage difference is changed during a floating section and the first section corresponding to a first polarity of the differentiation value is longer than a second section corresponding to a second polarity thereof.

8. A zero crossing point estimating circuit comprising:
a subtractor outputting a voltage difference between back-electromotive force and a present reference voltage;
a differentiator differentiating the voltage difference with respect to a floating section;
an integrator integrating the voltage difference with respect to the floating section; and
a zero crossing point estimator estimating a zero crossing point using at least one of an output of the differentiator and an output of the integrator.

9. The zero crossing point estimating circuit of claim 8, wherein the zero crossing point estimator estimates a central point of the floating section to be the zero crossing point when the output of the integrator is 0.

10. The zero crossing point estimating circuit of claim 8, further comprising a pattern determiner determining whether the back-electromotive force and the reference voltage correspond to any one of preset forms depending on a result of the differentiation or the integration,
wherein the zero crossing point estimator estimates the zero crossing point depending on an output of the pattern determiner.

11. The zero crossing point estimating circuit of claim 8, wherein the zero crossing point estimator estimates a central point of the floating section to be the zero crossing point when the output of the differentiator has a positive value within an entire region of the floating section and the output of the integrator is not 0.

12. The zero crossing point estimating circuit of claim 8, wherein the zero crossing point estimator estimates a central point of the floating section to be the zero crossing point when the output of the differentiator has a negative value within an entire region of the floating section and the output of the integrator is not 0.

13. The zero crossing point estimating circuit of claim 8, wherein the zero crossing point estimator estimates a central point of a first section to be the zero crossing point when a polarity of the output of the differentiator is changed within the floating section and the first section corresponding to a first polarity of the output of the differentiator is longer than a second section corresponding to a second polarity thereof.

14. A motor driving control method performed by a motor driving control apparatus of controlling driving of a motor apparatus, comprising:
detecting back-electromotive force generated by the motor apparatus;
estimating a zero crossing point by performing at least one of differentiation and integration on a voltage difference between the back-electromotive force and a preset reference voltage; and
controlling phase switching of the motor apparatus using the zero crossing point.

15. The motor driving control method of claim 14, wherein in the estimating of the zero crossing point, it is judged that the zero crossing point is detected by the back-electromotive force and the reference voltage when an integration value of the voltage difference is 0.

16. The motor driving control method of claim 14, wherein in the estimating of the zero crossing point, it is judged whether the back-electromotive force and the reference voltage correspond to any one of preset forms depending on a result of the differentiation or the integration, and the zero crossing point is estimated depending on the judged form.

17. The motor driving control method of claim 14, wherein in the estimating of the zero crossing point, a central point of a floating section is estimated to be the zero crossing point when a differentiation value of the voltage difference has a positive value within an entire region of the floating section and an integration value thereof is not 0.

18. The motor driving control method of claim 14, wherein in the estimating of the zero crossing point, a central point of a floating section is estimated to be the zero crossing point when a differentiation value of the voltage difference has a negative value within an entire region of the floating section and an integration value thereof is not 0.

19. The motor driving control method of claim 14, wherein in the estimating of the zero crossing point, a central point of a first section is estimated to be the zero crossing point when a polarity of a differentiation value of the voltage difference is changed during a floating section and the first section corresponding to a first polarity of the differentiation value is longer than a second section corresponding to a second polarity thereof.
